(19) United States
(12) Patent Application Publication
(10) Pub. No.: US 2004/0040407 A1
(43) Pub. Date: Mar. 4, 2004

(54) Bicycle handlebar assembly having a light device

(76) Inventor: Shi Chuan Chen, Taichung (TW)

Correspondence Address: Alan D. Kamrath, Rider, Bennett, Egan & Arundel, LLP, 333 South Seventh Street, Suite 2000, Minneapolis, MN, 55402, US

(21) Appl. No.: 10/233,705

(22) Filed: Sep. 3, 2002

(51) Int. Cl. B62K 21/26

(52) U.S. Cl. 74/551.9

(57) ABSTRACT

A bicycle handlebar assembly includes a handlebar and a light device is connected to a distal end of the handlebar. A switch is connected to an outer periphery of the light device and batteries are received in the light device. A transparent cap is connected to the open end and includes a light reflection plate and a bulb is engaged with a hole defined through the light reflection plate. The transparent cap shows the signal at the distal end of the handlebar so that the driver behind the bicycle can clearly see the signal.

### FIELD OF THE INVENTION

The present invention relates to a bicycle handlebar assembly that has a light device connected to a distal end thereof.

### BACKGROUND OF THE INVENTION

A conventional bicycle safety device used for sending signal to the vehicles behind the bicycle is shown in FIG. 4 and generally includes a reflector device 62 which is connected to a rear fender 61 above the rear wheel 60. The reflector device 62 may reflect light from the vehicle so that the driver of the vehicle behind the bicycle is noticed that a bicycle is located in front of the vehicle. This is extremely important for the safety of the rider of the bicycle especially during night time. Nevertheless, the reflector device 62 is a passive device which is operated by the light beam from the vehicle. The passive reflector device 62 cannot show any turning signal to the vehicle behind the bicycle so that it has a potential risk for the rider of the bicycle.

The present invention intends to provide a handlebar assembly that has a light device connected thereto and the rider can operate the switch to show turning signal to the driver behind the bicycle.

### SUMMARY OF THE INVENTION

In accordance with one aspect of the present invention, there is provided a bicycle handlebar assembly which comprises a handlebar and a light device is connected to a distal end of the handlebar. A switch is connected to an outer periphery of the light device and the light device includes a close end and an open end to which a transparent cap is connected. An annular groove is defined in the close end so as to receive the handlebar therein. A light reflection plate is received in the transparent cap and a hole is defined through the light reflection plate. A bulb is engaged with the hole and a chamber is defined in the light device so as to receive batteries therein.

The primary object of the present invention is to provide a handlebar assembly that has a light device at a distal end thereof.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the handlebar assembly of the present invention;

FIG. 2 is a cross sectional view to show the the handlebar assembly of the present invention;

FIG. 3 is a perspective view to show the handlebar assembly of the present invention, and FIG. 4 shows a conventional reflector device of a bicycle.

### DETAILED DESCRIPTION OF THE PREFERRED EMBODIMENT

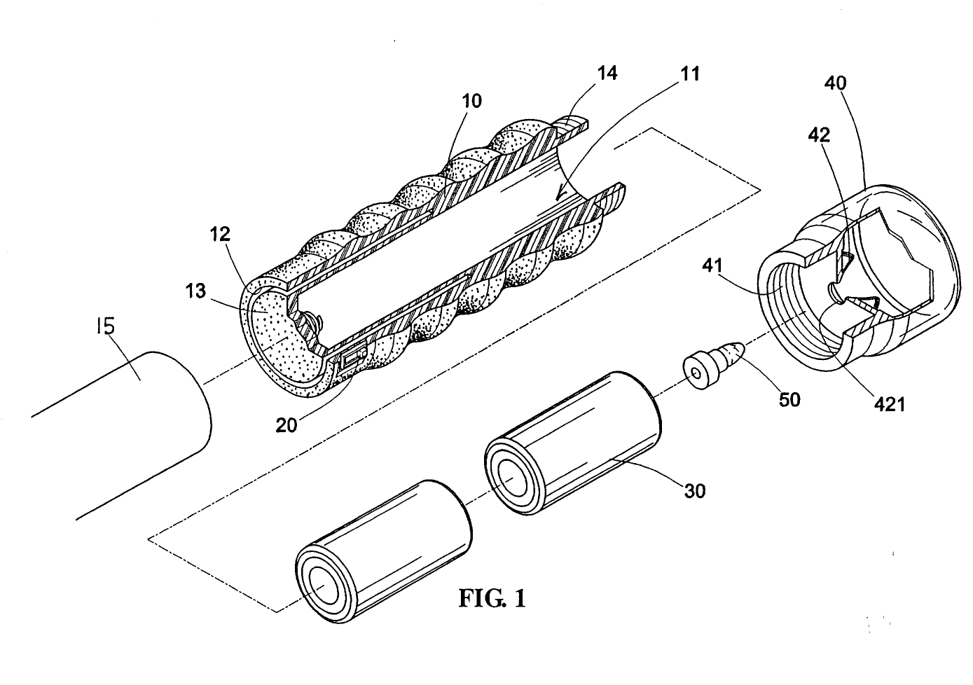

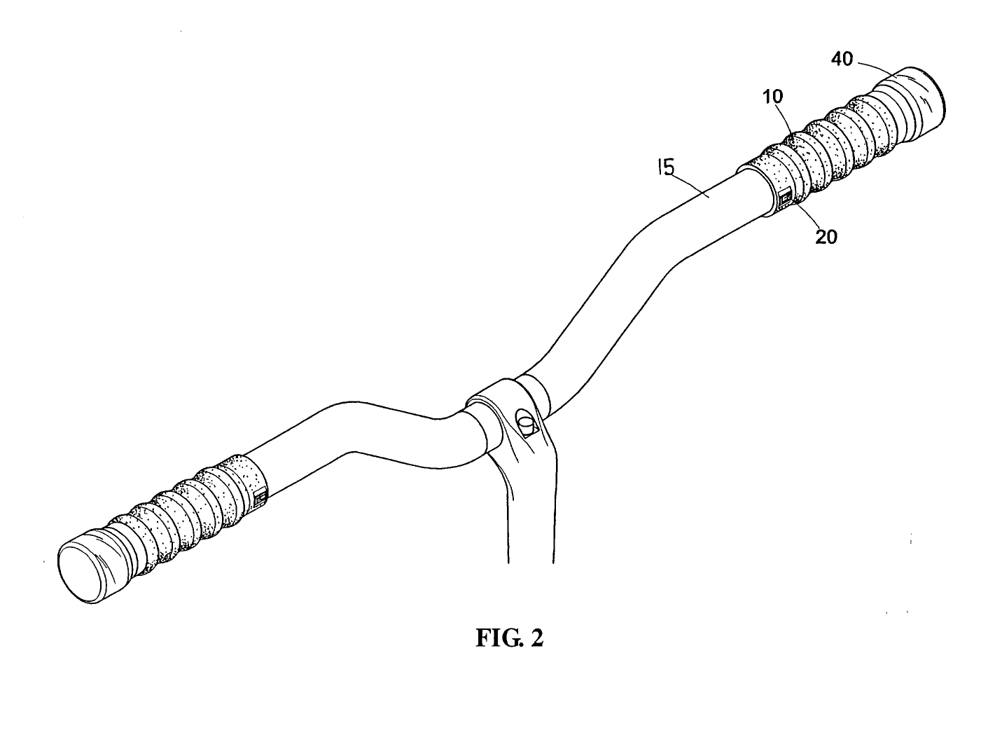

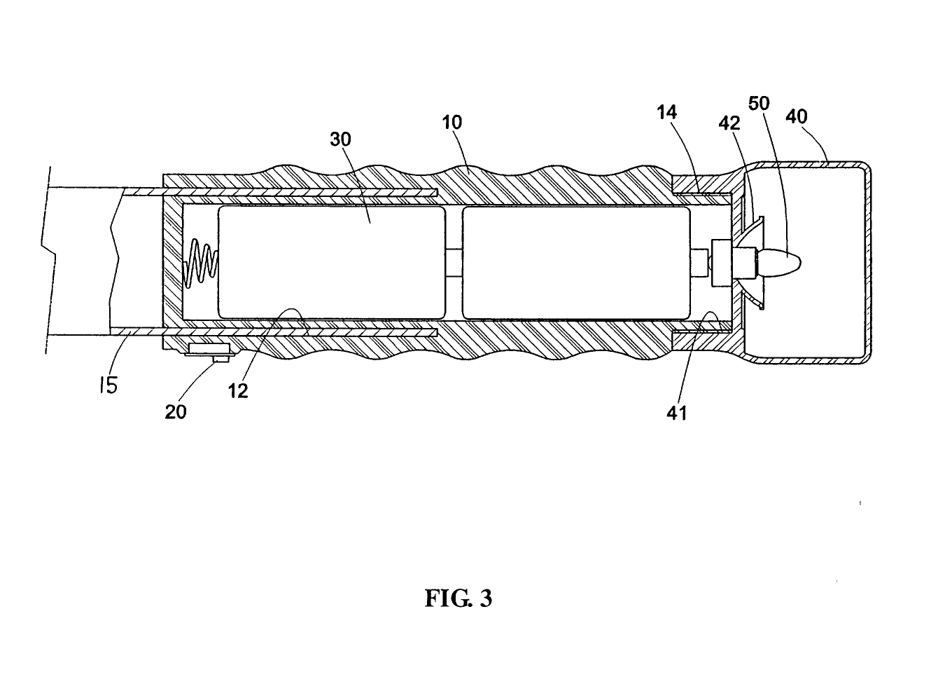

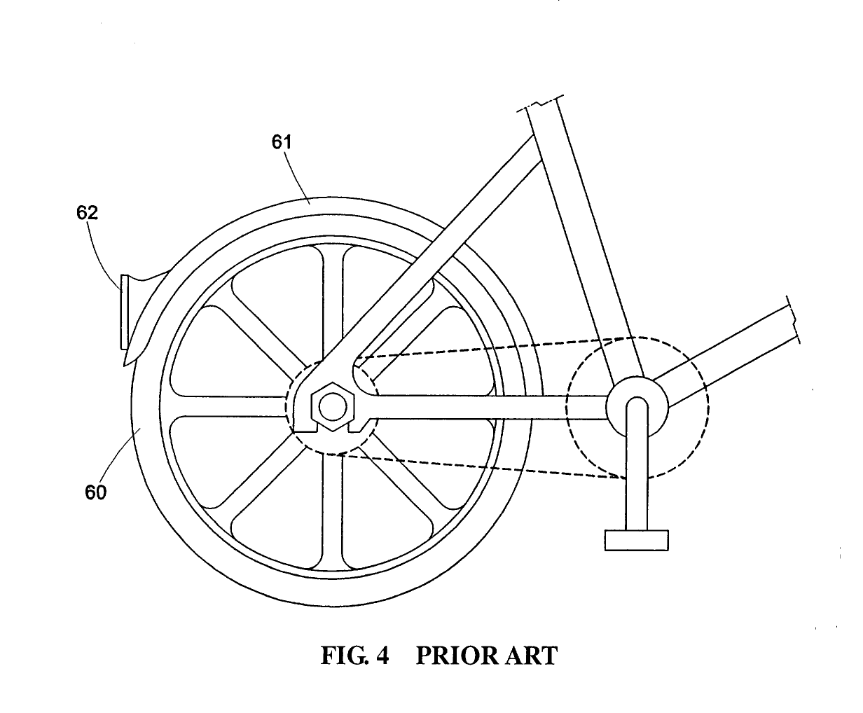

Referring to FIGS. 1 to 3, the bicycle handlebar assembly of the present invention comprises a handlebar 15 which is a hollow tube with an open end and a light device 10 is connected to a distal end of the handlebar 15. The light device 10 has a rubber-made outer layer. The light device 10 includes a close end 13 and an open end, wherein a threaded outer periphery 14 is defined in the open end of the light device 10 and an annular groove 12 is defined in the close end 13. The handlebar 15 is engaged with the annular groove 12. A transparent cap 40 has a threaded inner periphery 41 which is engaged with the threaded outer periphery 14 at the open end of the light device 10. A light reflection plate 42 is received in the transparent cap 40 and a hole 421 is defined through the light reflection plate 42 so that a bulb 50 is engaged with the hole 421. A chamber 11 is defined in the light device 10 so as to receive batteries 30 therein. The light device 10 has a switch 20 connected to an outer periphery of the light device 10 and is electrically connected in series with the batteries 30 and the bulb 50.

When turning the bulb 50 on, the light can be seen by the driver behind the bicycle via the transparent cap 40 so as to be used as a turning signal. The light device 10 may be disengaged from the handlebar 15 and used as a flashlight when needed.

While we have shown and described the embodiment in accordance with the present invention, it should be clear to those skilled in the art that further embodiments may be made without departing from the scope of the present invention.

What is claimed is:

1. A bicycle handlebar assembly comprising:
a handlebar, and
a light device connected to a distal end of the handlebar and having a switch connected to an outer periphery of the light device, the light device including a close end and an open end to which a transparent cap connected to the open end, an annular groove defined in the close end so as to receive the handlebar therein, a light reflection plate received in the transparent cap and a hole defined through the light reflection plate, a bulb engaged with the hole, a chamber defined in the light device so as to be adapted to receive batteries therein, the batteries, the switch and the bulb being electrically connected in series.

2. The handlebar assembly as claimed in claim 1, wherein light device has a rubber-made outer layer.
